(19) United States
(12) Patent Application Publication
(10) Pub. No.: US 2005/0006947 A1
(43) Pub. Date: Jan. 13, 2005

(54) Method for actuating an external-force parking brake system

(76) Inventor: Heiner Messner, Kornwestheim (DE)

Correspondence Address: RONALD E. GREIGG;GREIGG & GREIGG P.L.L.C., Suite One, 1423 Powhatan Street, Alexandria, VA, 22314, US

(21) Appl. No.: 10/870,961

(22) Filed: Jun. 18, 2004

(30) Foreign Application Priority Data
Jun. 18, 2003 (DE) 1 03 27 571.1

(51) Int. Cl. B60T 17/16

(52) U.S. Cl. 303/11; 303/89

(57) ABSTRACT

The invention relates to a method for actuating an external-force parking brake system of a hydraulic vehicle brake system that has a hydraulic pump. For actuating the parking brake system by external-force, the invention proposes pumping brake fluid with the hydraulic pump out of a wheel brake, by opening an outlet valve, into a wheel brake, which has a locking device for locking in the actuated state. A switchover valve is preferably closed, to avoid feedback effects on a master cylinder.

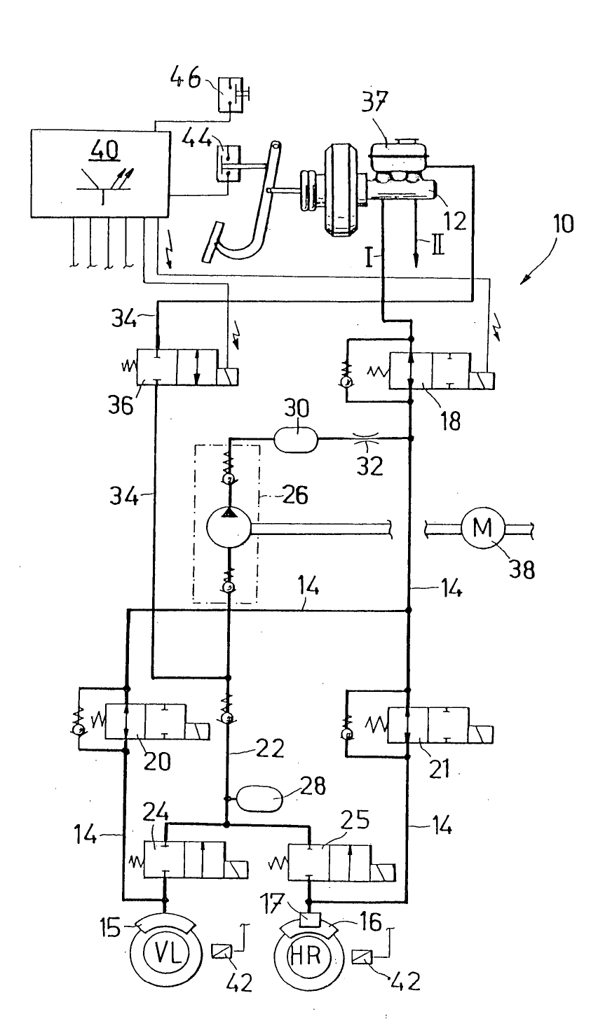

### BACKGROUND OF THE INVENTION

1. Field of the Invention

The invention relates to an improved method for actuating an external-force parking brake system in a hydraulic vehicle brake system.

2. Description of the Prior Art

It is standard now for passenger cars to be equipped with a hydraulic service brake system that is manually actuated by means of a pedal-actuated master cylinder. Typically, a negative-pressure brake booster is present, and electrohydraulic brake boosting with an electric-motor-driven hydraulic pump is also known. Often, the hydraulic service brake systems have an electric-motor-driven hydraulic pump, also called a return pump, for purposes of anti-lock braking, traction control, and/or electronic stability control (ABS, ATC, ESP), with which brake fluid can be pumped into or out of the wheel brakes in order to increase or decrease a wheel brake pressure in the wheel brakes. Below, for the sake of brevity, only anti-lock braking will be discussed. For that purpose, each wheel brake, or a group of wheel brakes, is preceded and followed by a brake pressure buildup and a brake pressure lowering valve, respectively. Such vehicle brake systems are known to one skilled in the art in various embodiments and will therefore not be described in further detail here.

Electrohydraulic service brake systems, that is, external-force service brake systems, are also known, in which a brake pressure is built up with an electric-motor-drivable hydraulic pump as the source of external energy. A brake pedal serves as the brake force set-point transducer, and a master cylinder is required only for auxiliary braking (emergency braking) if the external energy source fails. One such electrohydraulic vehicle brake system is disclosed in International Patent Disclosure WO 98/31576. The known vehicle brake system has an ABS device, which in principle is embodied identically to the ABS device described above in a muscle-or auxiliary-force brake system, with the specification that the hydraulic pump forming the external energy source is also used for anti-lock purposes.

European Patent Disclosure EP 0 995 659 A1 discloses a vehicle brake system with a hydraulic service brake system and a likewise hydraulic external-force parking brake system (parking brake). For embodiment as a parking brake system, wheel brakes of the vehicle brake system have hydraulically actuatable, releasable locking devices, with which the wheel brakes can be mechanically locked in the actuated state. A brake force that has been built up is as a result maintained even if pressure fails. The locking can be activated hydraulically, electromechanically, or in some other way. For unlocking the locking device and releasing the parking brake system, it may be necessary to actuate the service brake system in order to release a mechanical tightening of the locking device and to make it possible to release the locking device, or to release it easily.

A wheel brake with a hydraulically switchable mechanical locking device is disclosed in German Patent Disclosure DE 195 02 927 A1. The method of the invention can also be used to release the parking brake system, and therefore actuating the parking brake system should also be understood in the sense of releasing the parking brake system.

In the known vehicle brake systems, a feedback effect on the brake pedal or in general on an actuating device of the service brake system can occur when the external-force parking brake system is actuated while the service brake system is also actuated. Because brake fluid is pumped in pulsating fashion with the hydraulic pump, typically operated as a piston pump, vibration can be sensed in the depressed brake pedal. The brake pedal is also pulled away from under the driver's foot when the hydraulic pump aspirates brake fluid from a master cylinder. These effects, and especially the vibration of the brake pedal, can occur not only upon tightening but also upon release of the external-force parking brake system.

### OBJECT AND SUMMARY OF THE INVENTION

For actuating the parking brake system, the present invention provides that with the hydraulic pump, brake fluid from at least one wheel brake, which has no parking brake system, be pumped into at least one wheel brake that does have a parking brake system, and as a result a wheel brake pressure is built up in the at least one wheel brake that has a parking brake system. The wheel brake that has the parking brake system is actuated (pulled tight) as a result and is then locked with the locking device in its actuated position. In the ideal case, the brake fluid from the at least one further wheel brake suffices to actuate the wheel brake that has the locking device. No brake fluid for external-force actuation of the parking brake system is aspirated from the master cylinder, which has the advantage that when the master cylinder is actuated, a foot brake pedal or other actuating device is not moved in the actuation direction, or in other words is not “pulled away” from under the driver's foot. If the brake fluid from the at least one further wheel brake does not suffice to actuate the wheel brake that has the locking device, then brake fluid can additionally be aspirated directly, bypassing the master cylinder, from a brake fluid supply tank.

The invention is especially suitable for vehicle brake systems with so-called X brake circuit distribution, or for vehicle brake systems in which all the wheel brakes are connected hydraulically parallel, as is typically the case in electrohydraulic vehicle brake systems. X brake circuit distribution means a vehicle brake system with two brake circuits hydraulically disconnected from one another, in which the wheel brakes of one front wheel and of the diagonally opposite rear wheel are connected to one brake circuit. In a II brake circuit distribution, in which the wheel brakes are connected axle by axle to a brake circuit, one front and one rear wheel must be equipped with a locking device in order to perform the method of the invention, or else some possibility must be created so that with the hydraulic pump of one brake circuit, brake fluid can be pumped into the other brake circuit. A further alternative would be to actuate only one wheel brake.

The invention also provides for disconnecting a muscle-power-actuatable master cylinder of the service brake system, for external-force actuation of the parking brake system, hydraulically from the vehicle brake system. This is preferably done by closing one typically present switchover valve for each brake circuit, which valve connects the master cylinder to the brake circuit or disconnects them. As a result, a feedback effect on the master cylinder and its actuating device is avoided; for instance, no pulsations, which the hydraulic pump typically embodied as a piston pump generates because of its discontinuous mode of pumping, are perceptible in the foot brake pedal.

### BRIEF DESCRIPTION OF THE DRAWING

The invention will be better understood and further objects and advantages thereof will become more apparent from the ensuing detailed description of a preferred embodiment taken in conjunction with the sole drawing figure which shows a hydraulic circuit diagram of a vehicle brake system for performing the method of the invention.

### DESCRIPTION OF THE PREFERRED EMBODIMENTS

The drawing shows a hydraulic vehicle brake system 10 with a dual-circuit master cylinder 12, to which two brake circuits I, II independent of one another are connected; of them, only brake circuit I is shown in the drawing.

A branching master brake line 14 leads from the master cylinder 12 to two wheel brakes 15, 16, connected to this brake circuit I, and of these one wheel brake 16 has a locking device 17, with which the wheel brake 16 can be fixed, that is, mechanically locked, in the actuated position. Thus the vehicle brake system 10 has a hydraulically actuatable external-force parking brake system. The wheel brakes 15, 16 connected to one brake circuit I are assigned to one front wheel and one diagonally opposite rear wheel of a vehicle; the wheel brakes 15, 16 of the other brake circuit II are assigned to the other two vehicle wheels. The vehicle brake system shown and described accordingly has what is known as an X brake circuit distribution.

A switchover valve 18 that is open in its basic position is disposed in a common portion of the master brake line 14. Two inlet valves 20, 21 that are open in their basic position are also disposed in the branching parts of the master brake line 14 and are each upstream of one wheel brake 15, 16. From the wheel brakes 15, 16, a uniting return line 22, in which one outlet valve 24, 25 that is closed in its basic position is disposed for each of the two wheel brakes 15, 16, leads to the intake side of a hydraulic pump 26, which is also called a return pump. A hydraulic reservoir 28 is connected to the return line 22.

A pressure side of the hydraulic pump 26 is connected to the master brake line 14 via a damper chamber 30 and a throttle 32 between the switchover valve 18 and the inlet valves 20, 21.

Via an intake line 34, in which there is an intake valve 36 that is closed in its basic position, the intake side of the hydraulic pump 26 is connected to a brake fluid supply tank 37, which is seated on the master cylinder 12.

The hydraulic pumps 26 of the brake circuits I, II both shown and not shown can be driven by a common electric pump motor 38. All the valves listed up to now, namely the switchover valve 18, the inlet valves 20, 21, the outlet valves 24, 25, and the intake valves 36, are magnet valves, which for purposes of anti-lock and traction control are controllable with an electronic control unit 40, which also switches the pump motor 38 on and off. The electronic control unit 40 receives signals from wheel rotation sensors 42, which are evaluated in order to ascertain an inclination of a vehicle wheel to lock upon braking or to ascertain slip upon starting up. The control unit 40 also receives a signal from a brake pedal sensor (brake light switch) 44, with which an actuation of the master cylinder 12 can be ascertained.

With the vehicle brake system described, service braking is possible in a manner known per se. Anti-lock, traction control and/or electronic stability control (ABS, ATC, ESP) are also possible in a manner known per se. Below, for the sake of brevity, only the anti-lock mode will be discussed. To that end, wheel brake pressures in the wheel brakes 15, 16 are regulated (modulated) for individual wheels by means of the electronic control unit 40, by clocked control of the inlet valves 20, 21 and outlet valves 24, 25, in the course of which the hydraulic pump 26 is put into operation. The switchover valve 18 is closed for the anti-lock mode, and as a result the master cylinder 12 is disconnected hydraulically from the rest of the vehicle brake system 10. For a rapid pressure buildup in a traction control and/or electronic stability control event, the intake valve 36 is opened, so that the hydraulic pump 26 aspirates brake fluid directly from the brake fluid supply tank 37.

For the external-force actuation of a parking brake system in the vehicle brake system 10, a button 46 or other operator control element is actuated. The electronic control unit 40 closes the switchover valves 18, so that the master cylinder 12 is disconnected from the rest of the vehicle brake system 10. The pump motor 38 of the hydraulic pump 26 is switched on, and the inlet valve 21 of the wheel brake 16 that has the locking device 17 is open or remains open, while conversely the inlet valve 20 of the wheel brake 15 that has no locking device is closed. The outlet valve 24 of the wheel brake 15 that has no locking device is opened, and the outlet valve 25 of the wheel brake 16 that has the locking device 17 is or remains closed. As a result, the hydraulic pump 26 aspirates brake fluid from the wheel brake 15 that has no locking device, and it pumps the brake fluid into the wheel brake 16 that does have the locking device 17. The latter wheel brake 16 is actuated (pulled tight) as a result, and after that in the actuated state is fixed or locked with the locking device 17. The brake force built up continues to be maintained as a result of the locking with the locking device 17, even when there is no pressure, when the hydraulic pump 26 is at a stop and currentless, or in other words when the magnet valves 18, 20, 21, 24, 25, 26 have dropped back into their basic positions. If the brake fluid aspirated from the wheel brake 15 that has no locking device does not suffice for an adequate pressure buildup in the wheel brake 16 that has the locking device 17, then by opening the intake valve 36 brake fluid can additionally be aspirated from the brake fluid supply tank 37.

The method of the invention can be performed in principle in the same way in other hydraulic vehicle brake systems that have a parking brake system, for instance including electrohydraulic vehicle brake systems. What is necessary is that from at least one wheel brake 15, brake fluid can be pumped with the hydraulic pump 26 into at least one other wheel brake 16 that does have a locking device 17. Therefore vehicle brake systems 10 in particular with an X brake circuit distribution or electrohydraulic vehicle brake systems, in which the wheel brakes are connected hydraulically parallel, are suitable for performing the method of the invention. In a II brake circuit distribution, in which the two front wheels are assigned to one brake circuit and the two rear wheels to another brake circuit, it would for instance be necessary for one front and one rear wheel, assigned to different brake circuits, each to have a locking device (not shown). Another possibility would be a hydraulic communication between the two brake circuits, or between wheel brakes both brake circuits, via a magnet valve (not shown) or via fixing (locking) only one vehicle wheel.

For releasing the locking device 17, a wheel brake pressure in the wheel brake 16 that has the locking device 17 can be built up with the hydraulic pump 26, in order to mechanically untense the locking device 17, making it easily releasable or unlockable. The pressure buildup in the wheel brake 16 is effected as in the actuation (pulling tight) of the wheel brake 16 as described above.

The foregoing relates to a preferred exemplary embodiment of the invention, it being understood that other variants and embodiments thereof are possible within the spirit and scope of the invention, the latter being defined by the appended claims.

1. A method for actuating an external-force parking brake system in a hydraulic vehicle brake system that has a hydraulic pump, in which the parking brake system has a wheel brake with a locking device, and the vehicle brake system has a service brake system with at least one further wheel brake, the method comprising pumping brake fluid from the at least one further wheel brake (15) by the hydraulic pump (26) to the wheel brake (16) that has the locking device (17) in order to actuate the parking brake system.

2. The method of claim 1, further comprising hydraulically disconnecting a master cylinder (12), actuated by muscle power, of the service brake system from the vehicle brake system (10) to actuate the parking brake system.
